(19) United States
(12) Patent Application Publication
(10) Pub. No.: US 2007/0279228 A1
(43) Pub. Date: Dec. 6, 2007

(54) Media access control and signaling protocol for low power, large-scale wireless networks

(75) Inventors: Martin Morris, Vista, CA (US); Anand Anandakumar, San Diego, CA (US); Aliazam Abbasfar, Mountain View, CA (US)

Correspondence Address: Stephen Ackerman;George O Saile and Assocs, 28 Davis Ave, Poughkeepsie, NY, 12603, US

(73) Assignee: Jaalaa, Inc.

(21) Appl. No.: 11/809,343

(22) Filed: May 31, 2007

Related U.S. Application Data
(60) Provisional application No. 60/809,544, filed on May 31, 2006.
(60) Provisional application No. 60/842,788, filed on Sep. 7, 2006.

(51) Int. Cl. G08B 13/14; G06F 17/00; G08B 5/22

(52) U.S. Cl. 340/572.1; 340/825.49; 235/375

(57) ABSTRACT

An implementation of a signaling protocol for low power and large scale wireless networks provides a media access control (MAC) that produces a low rate two-way communication link between a commercial infrastructure and a very large number of small, low-cost devices known as electronic tags. The numerous tags attached to merchandise or shelves communicate with a number of access points (AP) distributed throughout a facility containing merchandise for sale or storage. A store controller maintains the pricing database for the point of sale (POS) registers of the facility. Price changes are transmitted in real time to the tag, thus updating the merchandise tags and the point of sales (POS) registers simultaneously. The tags contain a controller and a battery in which conservation of power is crucial to the life of the tags.

This application claims priority to Provisional Patent Application Ser. No. 60/809,544, filed on May 31, 2006, which is herein incorporated by reference in its entirety.

This application claims priority to Provisional Patent Application Ser. No. 60/842,788, filed on Sept. 7, 2006, which is herein incorporated by reference in its entirety.

### BACKGROUND OF THE INVENTION

1. Field of Invention

The present invention relates wireless networks and in particular low power, large-scale wireless networks

2. Description of related art

In business locations such as retail stores containing many products for sale, inventory control and price adjustments have historically been accomplished by manual methods. This is a slow and labor intense process and further complicated by changing display locations to satisfy marketing choices. With the advent of wireless networks the ability to track product and adjust changes such as pricing is becoming more automated. The use of wireless networks provides improved productivity with better inventory control and faster updates, freeing employees to perform other tasks. Wireless electronic tag units attached to product and product shelves provides a mechanism by which product can be tracked, controlled and dynamically priced.

In U.S. Pat. No. 6,870,464 (Okmura) an inventory control system is directed to small volume product where a plurality of electronic tag units are installed in a floor in which installation locations are stored. U.S. Pat. No. 6,446,208 (Gujar et al.) is directed to a system for identifying multiple electronic tags including a plurality of electronic tags attached to single object. U.S. Pat. No. 6,089,453 (Kayser et al.) is directed to a product information display system that uses electronic tags for displaying pricing and product information. U.S. Pat. No. 5,892,441 (Wooley et al.) is directed to attaching an electronic tag to an object in storage or a moving vehicle to detect the presence of the object. U.S. Pat. No. 5,797,132 (Altwasser) is directed to an electronic labeling system for displaying price information on an edge of shelves of a store.

With the advances in electronic tagging of product there is a need to provide a system that not only can provide tracking of a product and update to product pricing at a shelf location, but to be able automatically locate the product as it is moved to different locations, update product pricing, and provide the pricing update to a point of sale. Further this needs to be done in an environment that is potentially noisy with other wireless electronic signals with a system in which a handshake is performed between sending and receiving elements of the system.

### SUMMARY OF THE INVENTION

It is an objective of the present invention to provide a large-scale wireless network within which electronic tags attached to items and merchandise, or shelves adjacent to items and merchandise, are monitored and updated from an access point communicating with the electronic tags.

It is also an objective of the present invention to provide a communication between a plurality of access points and a plurality of electronic tags.

It is another objective of the present invention to automatically communicate between the access point and the electronic tags using a handshake method where a response to a message is acknowledged by the receiving unit.

It is further an objective of the present invention to automatically determine a new location of moved merchandise and re-establish wireless communication between a tag and another access point having wireless coverage of the new location.

It is also further an objective of the present invention to couple data stored in a point of sales unit, such as recent price to an electronic tag attached to merchandise.

It is still further an objective of the present invention to communicate with redundancy between a tag and an access point to facilitate noise avoidance.

It is yet another objective of the present invention to automatically commission and register a tag attached to an item with the wireless network.

It is also yet another objective of the present invention to be able to replace a failed access point and automatically re-establish communication between a replacement access point and the tags wirelessly coupled to the failed access point.

An implementation of signaling protocol for low power and large scale wireless networks provides a media access control (MAC) that produces a low rate two-way communication link between a commercial infrastructure and a very large number of small, low-cost devices known as electronic tags. The numerous tags attached to merchandise and shelves communicate with a number of access points (AP) distributed over the ceiling area, or walls of a facility containing merchandise for sale or storage. A store controller maintains the pricing database for the point of sale (POS) registers of the facility. Price changes are transmitted in real time to the tag, thus updating the merchandise tags and the POS registers simultaneously. The tags contain a controller and a battery. Due to the extreme low power design of the system, a single coin-type non-rechargeable lithium battery lasts in excess of four years. Low power consumption in the tags is crucial in the operation of the system; therefore tags sleep for all but a few milliseconds out of every two seconds. Then the tags wakeup briefly for communication with the access points resulting in approximately about ⅓ of the tag battery consumption. A design point of active price updating at a rate of once per hour accounts for another approximate ⅓ of the battery consumption, and the rest is consumed as leakage current. Other system requirements include isolating the internal operation of the system from the store controller, requiring a bare minimum of system training for store personnel, and flexibility to commission tags. Application software under which the MAC operates is provided by the store or facility.

In the store environment an AP (access point) pages one or more tags that are associated to the AP by address. The tag receives a data packet from the AP and sends an acknowledgement (ACK) back to the AP. The AP then sends an end of message (EOM). If the ACK or the EOM are not received additional attempts are made to insure that the data sent to the tag was received.

Commissioning the tag and registering the tag with an AP in the communication vicinity of the AP is performed by the AP sending a message to a reserved address (RA) and looking for a response from the tag on a second reserved address, where the response of the tag is its unique identification (UID) for commissioning and its short identification (SID) for registration.

### BRIEF DESCRIPTION OF THE DRAWINGS

This invention will be described with reference to the accompanying drawings, wherein:

FIG. 1 is a system diagram of the present invention;

FIG. 2 is a diagram of the present invention of a basic communication frame structure;

FIG. 3 is a diagram of a sub-beacon of the present invention;

FIG. 4 is a diagram of a data slot structure of the present invention for communicating between an access point and an electronic tag;

FIG. 5 is a diagram of the present invention of a null beacon structure;

FIG. 6 is a flow diagram of the present invention for a tag listening to receive a message from an access point;

FIG. 7 is a flow diagram of the present invention for efficient communication between a tag and an access point;

FIG. 8 is a flow diagram of the present invention for communicating a data packet to a tag from an access point;

FIG. 9 is a flow diagram of the present invention for acknowledging receipt of data by the tag;

FIG. 10 is a flow diagram of the present invention for registration of a tag with a point of access;

FIG. 11 is a flow diagram of the present invention for commissioning a tag;

FIG. 12 is a flow diagram of the present invention for updating a tag; and

FIG. 13 is a flow diagram of the present invention for handling a failed access point.

### DETAILED DESCRIPTION OF THE PREFERRED EMBODIMENT

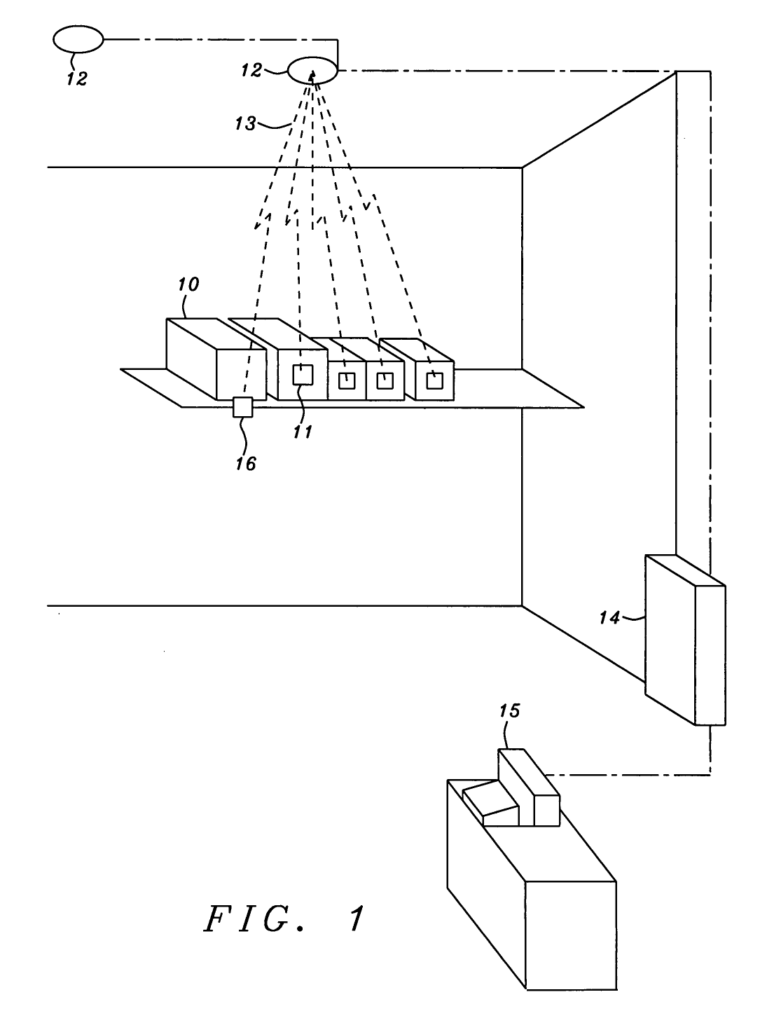

In FIG. 1 is shown a system of the present invention where merchandise 10 is on a shelf in an area within a store. Merchandise 10 can have an electronic tag 11 attached or the shelf upon which the merchandise rests can have an electronic tag 16. An access point (AP) 12 located in the vicinity of the merchandise 10 communicates by RF signals 13 with the tags 11 and 16 to track and update product parameters such as price. A plurality of access points 12 are distributed within a store to provide a store wide coverage that communicates with a plurality of electronic tags known as merchandise tags. A store controller 14 communicates with the AP units 12 distributed around the store where each AP unit 12 communicates with tag units 11 attached to merchandise, or attached to shelves close to the merchandisel6, in the RF communication domain (vicinity) of each AP unit. The store controller 14 also is coupled to a point of sale (POS) register 15 to provide updates of price and other parameters simultaneously to updates provided to the tag units 11 and 16 from the AP unit 12.

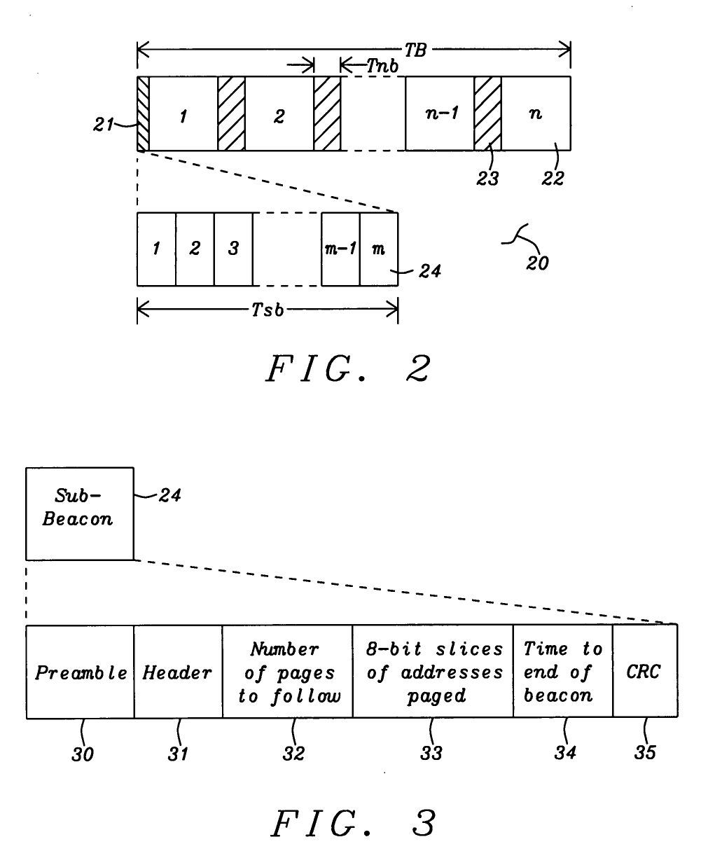

Referring to FIG. 2, an AP (access point) 12 of the present invention provides communication with many tags up to approximately fifty meters away. Due to the size of stores and considerations such as RF shadowing, access points are distributed around the store to provide complete coverage. Multiple AP units also provide increased update capability by operating independently on different RF channels. Tags 11 are associated with a single AP by selecting a channel and monitoring that channel for messages called pages.

Pages are sent in clusters in a message called a beacon 21. Beacons are transmitted by AP units every TB seconds, regardless of traffic. Each beacon contains up to eight or sixteen addresses of tags for which the AP has data. The frame 20 comprises a beacon 21, data slots 22 and null beacons 23. A beacon 21 comprises a plurality of sub-beacons 24 at the beginning of a frame 20 containing the addresses of the tags attached to merchandise, which are to be updated and which are within the signaling domain of the AP. The sub-beacons 21 notify a tag (page the tag) when there is a message that is being sent from the AP for the tag to read.

A frame lasts for TB=2 seconds and is followed by the next frame. There are m=30 sub-beacons 24 at the beginning of a beacon 21 followed by a first data slot of n=16 data slots 22. In between data slots is a group of null beacons 23. The group of m=30 sub-beacons occupy the first Tsb=15.12 ms (milliseconds) of a frame where each individual sub-beacon lasts for 504 us (microseconds). The group of null beacon 23, comprises sixty-four individual null beacons, each of which last for 248 us to produce a time duration for the group of null beacons of Tnb=15.872 ms. The remainder of the TB=2 seconds of a frame is occupied with n=16 data slots 22. It should be noted that the number of elements and the elapsed time of those elements of a beacon are given as an example of a design point and may be changed without altering the intent of the present invention

FIG. 3 shows the structure of an individual sub-beacon 24. The individual sub-beacon comprises a preamble 30, a header 31, the number of message pages to follow 32, an eight bit slice of the address of the tag that is being addressed 33, the length of time to the end of the beacon 34 and a cyclic redundancy check (CRC) 35. The preamble 30 comprises a sequence of bits used to acquire synchronization with a transmitter, an AP. The preamble is based on the store ID from a set of maximally distant sequences to minimize any confusion and chances of a message being wrongly received from an adjacent store. The header 31 comprises information needed to properly interpret a message comprising the type of packet (a beacon for instance), transmitting access point ID and option flags.

Radio frequency channels are subject to impairments and interference. In order to improve the probability of the beacon reception by a tag, each sub-beacon is repeated five times during the beacon interval. If a tag that wakes up late and misses a single sub-beacon that sub-beacon will be repeated immediately after the previous sub-beacon; therefore, the need of the tag to wake up in time to catch the first sub-beacon is reduced, reducing power consumption requirements of the tag by not requiring the tag to always be on simultaneous to or slightly prior to the beginning of a beacon.

Each AP generates all beacons and sub-beacons on a single channel determined when the AP is installed. An AP changing channels is equivalent to removing an AP and installing another. The RF channels are coordinated by the installers to ensure that adjacent AP units do not use the same channel. AP units that are located remotely from one another in large stores may re-use the same RF channel. Part of the installation process is to select channels, which are not currently in use nearby. When a tag looks for an AP, tags near the edge of a store may hear an AP from an adjacent store, albeit on a different RF channel. To avoid tags from locking onto an AP from another system, each tag has a store identification that is pre-loaded. The store identification is used by the AP to generate the preambles used in all transmissions by the AP. This ensures that a tag will not even receive a transmission from an AP not located in the store.

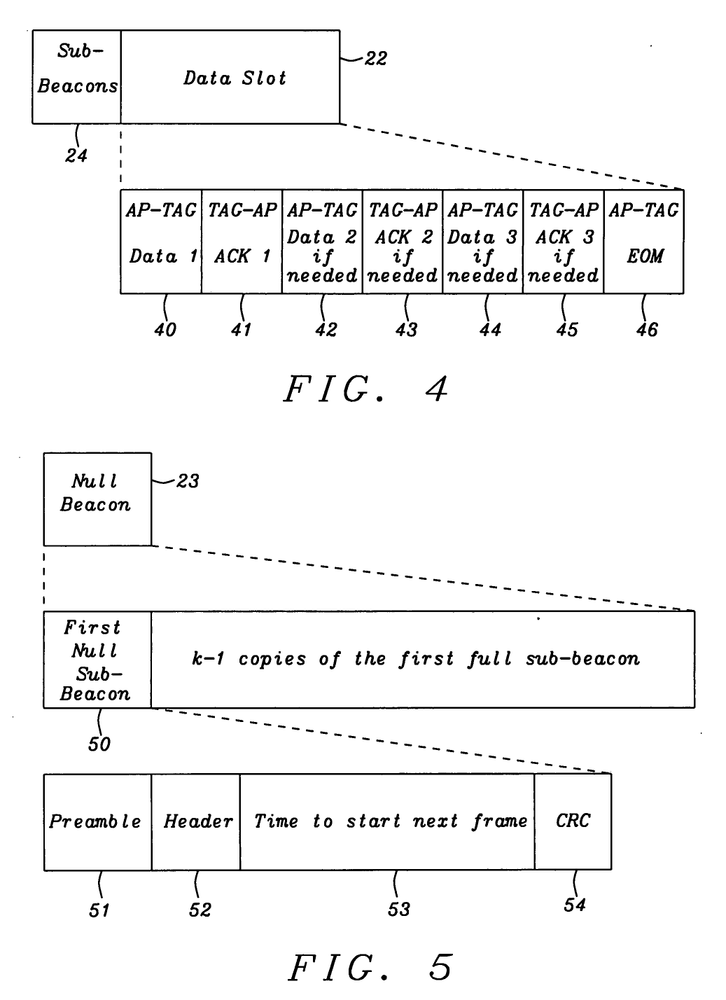

In FIG. 4 is shown the structure of a data slot 22 of a beacon. The first portion of a data slot 40 contains a message (data 1) from an AP 12 to a tag 11. Next is expected an acknowledgement (ACK) 41 from the tag to the AP. This is followed by a data message 42 (if needed) from the AP to the tag, which is followed by an ACK 43 from the tag. A third message 44 from the AP to the tag follows (if needed), followed by another ACK 45 from the tag to the AP pertaining to receiving the third message and then an end of message (EOM) 46 is produced by the AP after receiving an ACK from the tag.

When a tag is notified by a sub-beacon 24 of a pending message, the tag sleeps until the data slot containing the message from the AP. Then the tag wakes up and listens for a data packet 40 and 42, and if necessary 44. If the packet is received by the tag, the tag immediately transmits an ACK packet to the AP 41, 43, and 45. When an AP receives an ACK, it responds with an EOM packet 46. This three-way handshake guarantees that not only has the data been transferred, but that the tag is assured of the reception of the ACK from the tag.

Each AP conducts all data transfers independently with each paged tag. To facilitate system-wide notifications, a broadcast address (reserved address 7 or RA7) is allocated. This address appears as a page, which is recognized by all tags. Each tag listening to the beacon then listens to the associated data slot for the broadcast message, which is forwarded to application software un-interpreted by the media access control (MAC) layer of the tag. Broadcast messages are not acknowledged; therefore an AP transmitting a broadcast message repeats the broadcast message several times to maximize the probability of its reception. A one-bit sequence number in each packet header is used to filter duplicate broadcast messages. The sequence number bit also disambiguates the situation where an AP conducts a data transaction with a particular tag, but the EOM is lost, followed immediately by a new transaction with the same tag. Without the sequence number, the tag would not be able to distinguish between the retransmission of a first transaction because the ACK was lost and two consecutive transactions.

Tags normally try to hear every beacon in case the tag is paged. Tags may miss beacons due to interference, but the on-chip clock is accurate enough to “free-wheel” for about fifty seconds before synchronization is lost. In low traffic, low interference situations, such as overnight, a system operator may choose to extend battery life by skipping beacons, effectively slowing down the system. Tags may be directed to skip beacons via an API call. To utilize this feature, the AP controller should broadcast a message to all tags providing them with the desired sleep interval. The MAC of the tag provides this message (like all broadcast messages) to the application software, which can then invoke the API call to direct the MAC to sleep longer than normal.

In FIG. 5 is shown the data structure of a null beacon 23. There are k-1=63 additional copies of the first null sub-beacon 50 repeated during a null beacon 23. Each null sub-beacon contains a preamble 51, a header 52, a time to start the next frame 53 and a cyclic redundancy check, CRC 54.

A new or moved tag must find a channel with an active beacon stream to use. Since in a quiet system each AP only transmits a beacon for a few milliseconds every two seconds, the expedient way of listening to a channel to determine if a beacon is present would require listening for up to 2 seconds on each possible channel, which would consume an enormous amount of battery life. The listen time can be reduced by a factor of 16 by ensuring that at the start of each data interval the AP transmits briefly. These transmissions are called “null beacons” since they are similar to beacons but do not contain addresses.

A tag in the steady state never hears a null beacon. A tag searching for a beacon stream, however, only needs to listen on a channel for at most ⅛ second ( 1/16 of two seconds) to identify or rule out the presence of a beacon stream. This is considerably longer time than required by a tag that has been associated with an AP, and as a consequence consumes power at a higher rate. When scanning for a beacon it is only necessary to hear a single beacon or null beacon. This requires that the tag be on for only 1 ms for 9 evenly spaced points in time for 125 ms. No matter when listening by a tag starts, if a beacon stream is present at least one beacon or null beacon will be heard. Furthermore, since the sequence repeats every 125 ms, consecutive samples may be taken out of different frames, so long as the relative positions in the frame are maintained. The repetitions allows scanning to be performed across frequencies first taking consecutive samples of each channel for 1 ms, then sleep for 125 ms (one slot) minus the time spent sampling (1 ms times the number of channels) plus 125/9 ms or 14 ms, the offset to the next sample point. Then repeating the sampling across frequencies for a total of 9 times, which results in a full scan in approximately 9×125 ms, or 1.125 seconds. This still consumes 180 ms of battery power (if all 20 channels are scanned), which is too large. A compromise to minimize time to operation and yet not waste battery life when a tag is in storage, a tag performs a full scan each time they wake up, but only wake up for scanning every fifteen minutes.

If an AP fails, once the tag determines a loss of beacons, the tag will perform a full scan. If the tag fails to find a beacon stream from another AP, the tag will sleep for 15 minutes then try again. Once an AP is returned to service, all tags, which cannot hear another AP, will find an AP beacon in an average of 7½ minutes. Once the presence of a beacon stream is detected, the frame boundary (start of the real beacon) must be identified. This is facilitated by including the offset to the end of the frame in each null beacon. Any single null beacon may be lost due to interference. To minimize the probability of loss, each null beacon is repeated sixty-four times at the start of each data slot. Null beacons are always transmitted on the primary channel.

As an additional enhancement to the search process for a beacon, a tag may be pre-loaded with a list of channels in priority order to optimize the search process. Only when the list of channels is exhausted without finding a beacon stream, the tag will search all other channels. Since a search may be triggered by a short-term power failure, which re-boots the AP units, every 30 seconds during the long sleep between full scans, the tag re-checks the original channel by performing nine 1 ms receptions at 139 ms (125 ms plus 14 ms offset) intervals. After synchronization beacons may be missed due to interference. The clock of a tag is accurate enough to maintain synchronization for fifty seconds without receiving a beacon; if the interval since the last beacon exceeds fifty seconds, the tag must perform a search for a beacon stream.

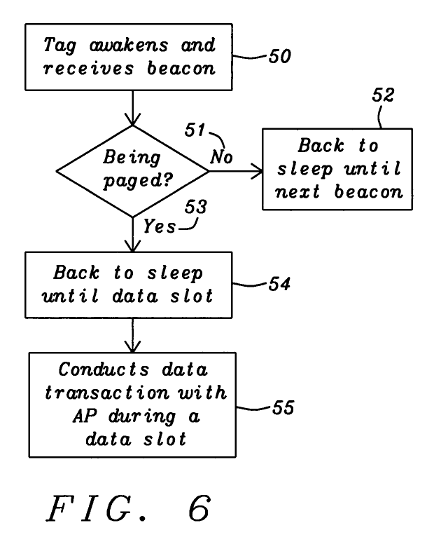

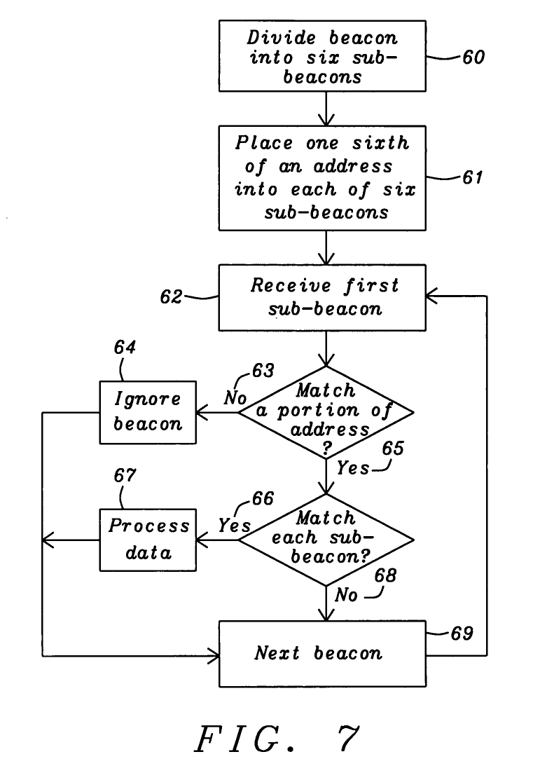

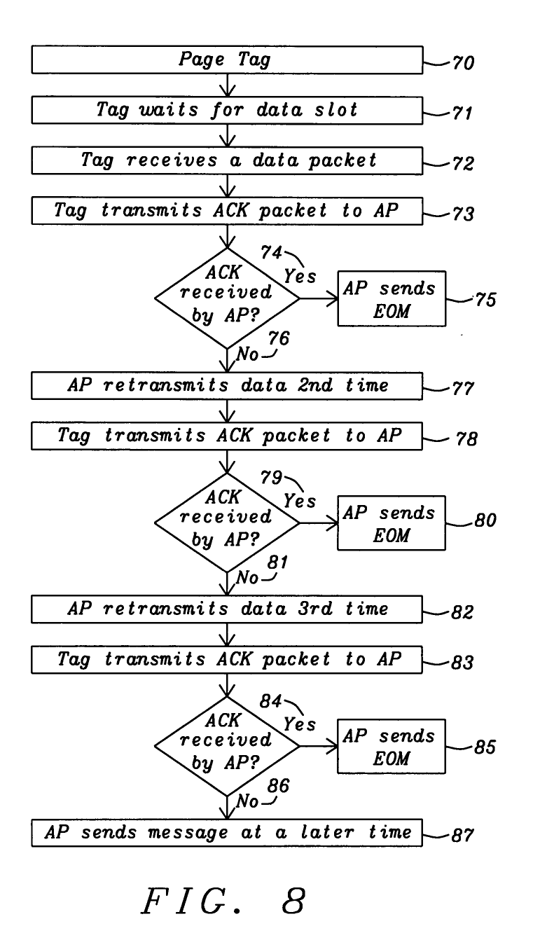

In FIG. 6 (referring to FIG. 2) is shown the method by which a tag normally communicates with an AP. Each tag wakes up synchronized with the beacon interval in each frame and receives the beacon 50. If the address of the tag is not being paged 51 or the beacon was missed because of interference, the tag returns to sleep until the next beacon 52. If the address of the tag is being paged 53, the tag goes back to sleep until the data slot 54, and then conducts a data transaction with the AP 55.

To reduce the time awake and power loss, each tag must quickly decide whether or not it is being paged in a beacon. The simple approach of transmitting from the AP up to sixteen addresses sequentially would require a tag, which is not being paged, to listen to all of the addresses to make a determination. Referring to FIG. 7, a method for improved efficiency in detecting a paged tag address is shown. The efficiency in reading the addresses being paged can be increased by dividing a beacon into six sub-beacons 60 transmitted independently, and putting one-sixth of each address into each of six sub-beacons 61. The tag receives the first sub-beacon 62 and each tag can then test one-sixth of its address against all addresses being paged. If none of portions of the paged addresses match 63, the rest of the beacon can be ignored 64 and the tag waits for the next beacon 69. Only when five-sixths of the address of a tag matches at least one of the paged addresses 65 does the tag need to receive the entire beacon 66. The tag processes the data 67 and proceeds to waiting for the next beacon 69. If a sixth sub-beacon does not match 68, a next beacon is viewed by then tag 69, and the tag returns to viewing the first sub-beacon 62 of the next beacon. On average, each tag thus only need to receive one-half of each beacon.

The data slot is considerably longer than required for a single transmission+ACK+EOM. The data slot is long enough for three data transmissions plus one ACK and one EOM including guard times to detect expected (but not heard) ACK after the first two data transmissions. If the AP does not hear an ACK promptly after it finishes transmitting the data, it retransmits the data immediately in the same slot. If it still does not hear an ACK, it tries a third time.

In FIG. 8 is shown a method of communications between an AP where the AP is sending a message to a tag (refer back to FIG. 3). When a tag is paged 70, the tag sleeps until the appropriate data slot 71, then wakes up and listens for a data packet. If the packet is received 72, it immediately transmits an acknowledgement (ACK) packet to the AP 73. When the AP receives an ACK 74, it responds with an end of message (EOM) packet 75. This three-way handshake guarantees that not only has the data been transferred, but that each end is assured of its reception. When an ACK is not received by the AP 76, the AP retransmits the data a second time 77, and the tag transmits an ACK packet to the AP 78. If an ACK is received back from the tag 79, the AP sends an EOM 80. If an ACK is not received by the AP 81, the AP sends the data for a third time 82, and the tag responds with an ACK 83. If an ACK is received by the AP after the third data send 84, the AP send an EOM to the tag 85. If no ACK for the third data send is not received 86, the AP sends the data at a later time 87.

Depending on system configuration, the AP will retransmit unacknowledged data packets still later. If the beacon is configured to contain only eight addresses and since there are always 16 data slots, there are two data slots available to that page, slot N and slot N+8. In the case that a data message is unacknowledged, the AP will retransmit the data in slot N+8. If still unacknowledged, or if the system is configured for 16 addresses per beacon, the AP will page the tag again in the next frame.

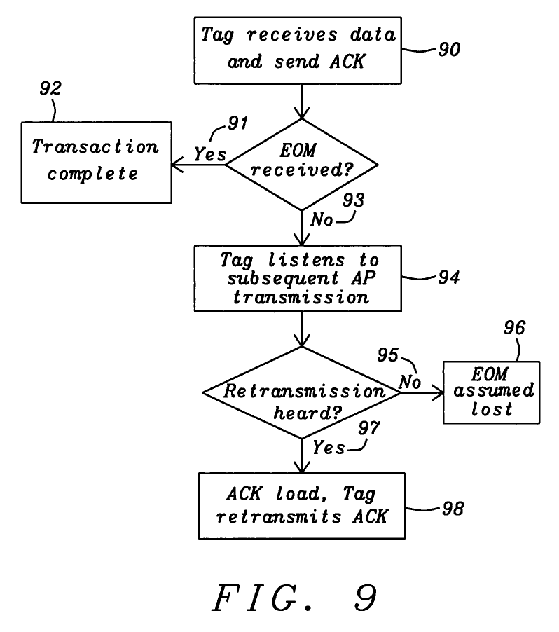

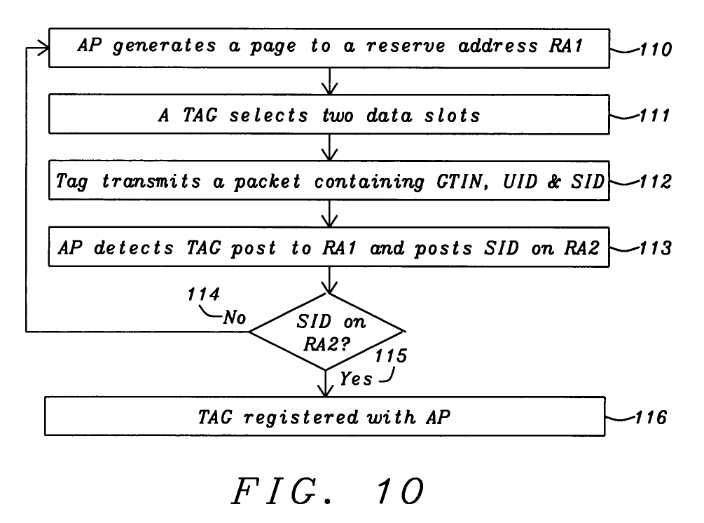

In FIG. 9 is the method for handling lost EOM from an AP. A tag receives data successfully and acknowledges the receipt of the message 90. If an EOM is received by the tag from the AP 91, the transaction is complete 92. If the tag does not receive an EOM 93, the tag does not know which packet was lost, the ACK or the EOM. The tag then listens during subsequent transmissions such as slot n+8 (if the beacon is so configured) to hear a retransmission 94. If no retransmission is heard 95, the EOM is assumed lost 96 and the tag assumes that any data it sent in response to the page was correctly received. If the retransmission is heard 97, the tag knows that the ACK was lost, and retransmits the ACK 98.

Each AP conducts all data transfers independently with each paged tag. To facilitate system-wide notifications, a broadcast address (reserved address 7 or RA7) is allocated. This address appears as a page, which is recognized by all tag units. Each tag listening to the beacon then listens to the associated data slot for the broadcast message, which is forwarded to application software un-interpreted by the MAC layer of the tag. Broadcast messages are not acknowledged, and an AP transmitting a broadcast message will repeat the broadcast message several times to maximize the probability of its reception. A one-bit sequence number in each packet header is used to filter duplicate broadcast messages. The sequence number bit also disambiguates the situation where an AP conducts a data transaction with a particular tag, but where the EOM is lost, followed immediately by a new transaction with the same tag. Without the sequence number, the tag would not be able to distinguish between an ACK for the first transaction ACK being lost and the ACK of the two consecutive transactions.

A tag will normally try to hear every beacon, in case the tag is paged. Tag units may miss beacons due to interference, but the on-chip clock of the tag is accurate enough to “free-wheel” for approximately fifty seconds before synchronization is lost. In low traffic and low interference situations, such as overnight, a system operator may choose to extend battery life of a tag by skipping beacons and effectively slowing down the system. Tag units may be directed to skip beacons with an API call. To utilize this feature, the AP controller will broadcast a message to all tag units, providing the tag units with a sleep interval. The MAC of the tag will provide this message (like all broadcast messages) to the application software, which will then invoke the API call to direct the MAC to sleep longer than normal.

If a tag hears a page but cannot subsequently receive the data transmission, the most likely problem is interference. Data transmissions in the first half of the data slots (the first 8) always occur on the same channel as the beacons. To provide a measure of frequency diversity, as a system option, the second half of the data slots (the second 8, used for retransmissions) may occur on a second frequency. This frequency must be communicated to the tag as part of a tag registering with an AP including the frequency diversity option and secondary channel. Beacons and null beacons are always transmitted on the primary channel regardless of the frequency diversity option.

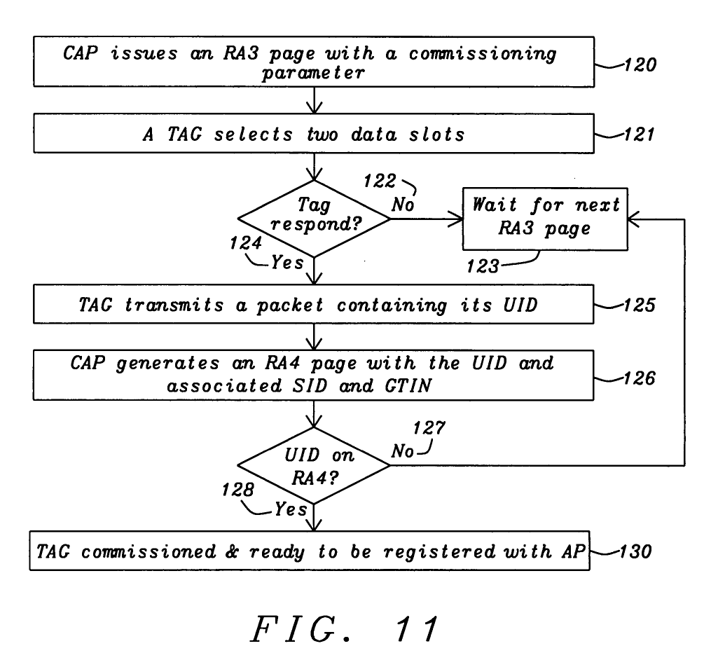

In FIG. 10 is shown a method for registration of a tag with an AP. An AP generates a page 110 to a reserved address RA1. A new or moved tag listens for the page on the RA1 address and selects sub-slot 111. The page generated by the AP specifies a pair of data slots n and n+8. Each of these data slots is partitioned into thirty-two sub-slots and a tag randomly selects one of these sixty-four sub-slots to which the tag will respond. The tag response comprises a packet containing a GTIN (global trade identification number), a UID (unique identification) and a SID (short identification) 112. The AP detects the post from the tag to RA1 and posts the SID on a page on RA2 (a second reserve address)113. If there is no SID on RA2 114, the next frame from the AP is a page to RA1 110 and the process is repeated. If the tag detects the SID on RA2 115, then the tag is registered with the AP 116 including the frequency diversity option and secondary channel.

Tag chips as produced by the factory are configured at chip test with a unique ID (UID) similar to the IEEE 802 MAC address. The UID is 41 bits long. In operation, to improve system efficiency and increase the update rate, a short ID (SID) is assigned to each tag that is 18 bits long, and is unique within each store system. Products in stores are identified by a number called the Global Trade Identification Number (GTIN). Subsets of the GTIN are currently called JAN codes in Japan, EAN codes in Europe, and UPC codes in the US. Each tag is associated with a single GTIN, and a system requirement is that multiple tags may be associated with each GTIN (although greater than 99% of the tags will be one-to-one for a GTIN).

Since the store controller is required to be isolated from tag operation, a database must be maintained in each AP associating GTIN with SID(s) served by that AP. Since products and their associated tags are sometimes moved around in a store, tags must be able to change their AP association. This implies that the AP database must be dynamically generated whenever a tag begins monitoring a beacon stream, and each tag must know the GTIN of the tag to supply to the new AP as part of registering presence of the tag to the AP.

Since an AP has no knowledge of a tag addition or movement, the tag must initiate the process of registering with an AP. This implies contention access. Note that normal tag updates are page/response, a deterministic process (except for interference) and do not require a contention access. An AP creates a contention access opportunity by periodically generating a page to a reserved address (RA1), which is only monitored by tag units awaiting an opportunity to register. The associated pair of data slots is further subdivided in time into 64 sub-slots. To register with an AP, a tag randomly selects one of the sub-slots and blindly transmits a packet containing its GTIN, UID, and SID.

Since the tag initiating communication does not know the alternate channel (if frequency diversity is enabled), all responses to RA1 pages are transmitted on the primary channel only, regardless of the diversity option. An AP never listens for RA1 responses on the alternate channel. When an AP hears at least one response to an RA1 page, it generates an RA2 page, and transmits a list of the SID numbers, which heard as data in both associated data slots. Any tag which has responded to an RA1 page but whose address is not in the RA2 list assumes that a collision occurred and responds again to the next RA1 page. Once its SID appears in an RA2 list, each tag may start normal operation of listening for a page containing its SID. The RA2 data packet also contains any configuration parameters needed by the tag to communicate with the particular AP with which the tag has registered including the frequency diversity option and secondary channel.

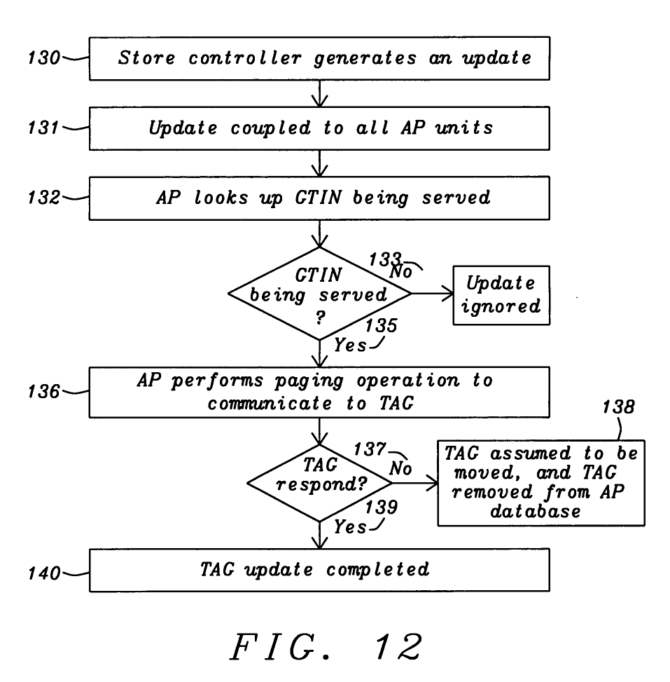

In FIG. 11 is shown the procedure for commissioning a tag. In order to perform their function, a tag needs to be provided with its assigned store ID, SID and GTIN. This information may be provided in a number of different ways, depending on the manufacturing and installation flow of the tags. To avoid potential difficulties in transit, short IDs must be programmed in the factory. The SID and the GTIN could also be programmed in the factory, but this creates a tracking problem. Instead, it is desirable to be able to program the tags over the air, either at the factory, at a reseller, or in the store. This process is called commissioning, and the bulk of the work is performed by customer application software.

Tags usually have paper labels on them, identifying the product. These labels may be placed on the product either at the time of commissioning a tag or afterwards. Handling a large number of tags is unwieldy, so the most straightforward process is to bulk commission tags over the air, and then have them display their GTIN so that the proper label can be affixed when the tag is placed on the shelf.

To commission a tag over the air, an AP must be supplied with a list of the GTIN numbers that need tags, the quantity of tags for each GTIN in the list, and the range of SID numbers previously assigned. An AP may or may not have access to this information via the infrastructure, but it is assumed here that a commissioning AP (CAP) has access to the required information.

Prior to commissioning, a tag only knows its UID and store ID. Depending on customer needs, a commissioning channel number may also be pre-configured, or the tag pre-configured to scan for a commissioning AP and by default, a fixed channel number is used. When a set of tags is to be commissioned, they must be physically placed in the coverage area of an AP that has been designated as the commissioning AP known herein as a CAP. After a few minutes, all the tags will be synchronized with the CAP and commissioning can be performed.

As shown in FIG. 11, a CAP issues an RA3 page with a commissioning parameter 120. The tag to be commissioned selects a sub-slot from a pair of slots associated with the page 121, similar to that which was done for registration and the tag then uses a combination of the RA3 parameter and a pre-programmed lookup table to generate a probability of responding. The tag uses the probability of responding to decide to decide to respond now or wait. If the tag decides not to respond 122, the tag waits for the next page from the CAP 123. If the tag decides to respond 124, the tag transmits a data packet containing the UID of the tag 125. The CAP generates a response on an RA4 page containing the UID, SID and GTIN of the tag being commissioned 126. If the tag does not see its UID on the RA4 page 127, the tag returns to wait for the CAP to issue another RA3 page 123. If the tag finds its UID listed on the RA4 page 128, the tag is commissioned 129 and is ready to be registered with an AP in the vicinity of where the product with the tag is to be located. Once a tag is ready to register, it must display its GTIN so that a human can tell which tag is which. If the CAP is also a regular AP, it may be periodically issuing RA1 pages, and, if so, the tag will register with it. When the tag is moved to a shelf or another location, the tag will re-register with another AP that is covering that location.

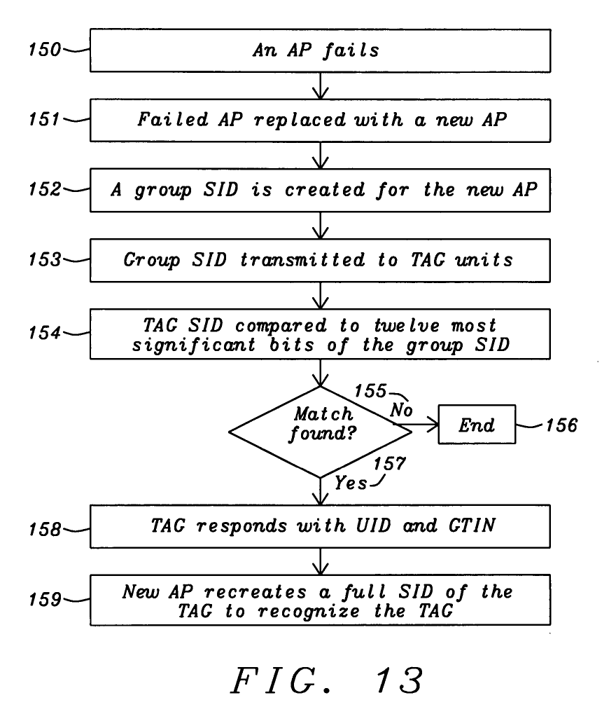

In FIG. 12 is shown the procedure for tag update processing of the present invention. Once a tag has registered with an AP, it waits for a page of its SID. At this point, the serving AP has an entry in its database for the tag. When the store controller generates a price change or other update 130, the message is passed to all AP units 131. Each AP looks up the GTIN in its database 132 and determines if there are any tags for that GTIN that it is serving. If there is not a tag associated with the AP that has the GTIN 133, the update is ignored 134. If a tag with the GTIN is being served by the AP 135, the AP generates a separate update message for each SID and performs a paging operation to communicate to the tag affected 136. If the tag responds 139, the tag update is completed 140. After the transactions are completed, including any retransmissions, the AP is informed whether or not each tag responded. If a tag does not respond for some number of tries 137, it is assumed that the tag has moved and the database entry deleted 138.

In FIG. 13 is shown the procedure associated with a failed AP of the present invention. An AP controller maintains the database described above that identifies merchandise associated with a tag. The AP database is an integral part of the system, and if the system stops working, the data is lost. If an AP fails and is subsequently replaced by one that does not have the database, the tags need a way to know to re-register, but the new/replacement AP doesn't know the tags are there. Therefore, the system needs a mechanism for an AP to proactively refresh its database, especially when it first starts up.

In order to implement this mechanism, a new addressing scheme is used. A group SID (GSID), which is a SID with the least significant six bits as wild cards, is used. Thus, a tag with a given SID matches a GSID if the most significant twelve bits match. This means that a page using a GSID is the same as a page of sixty-four consecutive SID numbers. An associated pair of data slots is divided into sixty-four sub-slots same as done for RA1 and RA3 pages. Anywhere from zero to sixty-four tags may hear and match a GSID page. Those tags that do, send their UID and GTIN as data in a sub-slot. In this case, the sub-slot is not randomly chosen, but instead matches the least significant 6 bits of the SID of the tags. The response is therefore not a contention access, and collisions are not possible. Also, since the tag knows the alternate channel (if any), the redundancy option determines the channel used by the tag to transmit its response if it occurs in the second-half slot of the pair.

In the flow diagram of FIG. 13, an AP fails 150 and the failed AP is replaced with a new AP 151. A first group SID (GSID) is created for the tags that were previously associated with the failed AP 152 and is transmitted to the tag units 153. The affected tags compare the twelve most significant SID bits to that of the GSID 154. If a match is not found by a tag 155, the process ends 156. If a match is found by a tag 157, the tag responds to the new AP with its UID and GTIN 158. The new AP recreates a full SID to recognize the tag that is responding 159. For each sub-slot that contains a response, a full SID is constructed from the most significant twelve bits of the GSID and the six bit representation of the sub-slot containing the response, and the SID, UID and GTIN in the tag response are sent to the AP controller. The GSID paging process is repeated with other GSID numbers as necessary to insure that all possible SID numbers have been paged

While the invention has been particularly shown and described with reference to preferred embodiments thereof, it will be understood by those skilled in the art that various changes in form and details may be made without departing from the spirit and scope of the invention.

What is claimed is:

1. A communication network for tracking and controlling merchandise, comprising:
a) a network to track and update price and merchandise parameters, further comprising;
i) an electronic tag coupled to merchandise;
ii) an access devices operating in each of a plurality of access points, wherein each access point communicates with a plurality of said electronic tags within a communication vicinity of each of the plurality of access points, whereby each of the electronic tags are identified by an address;
iii) a controller communicating with said plurality of access points and a point of sales terminal to maintain inventory control and price information;
b) said plurality of access points located on ceilings or walls of a store and communicating with a plurality of the electronic tags within a communication vicinity of each of said access points with wireless signals comprising a plurality of communication channels;
c) said electronic tags register with a first access point and re-register with a second access point when moved to a communication vicinity of said second access; and
d) said electronic tags listen to signal beacons broadcast from the access points for an identification (ID) of the electronic tags and respond with an acknowledgement when the ID of a particular tag is received after which data is transmitted to the particular tag.

2. The network of claim 1, wherein said electronic tags are attached to merchandise.

3. The network of claim 1, wherein said electronic tags are attached to shelving or other merchandise displays containing merchandise.

4. The network of claim 1, wherein access points are distributed throughout a store and have communication responsibility with the electronic tags within the vicinity of the access devices.

5. The network of claim 1, wherein said tags awaken to receive said signal beacons and return to sleep to conserve power when not being paged by said access points.

6. The network of claim 1 wherein said tags awaken to receive said signal beacons and returns to sleep to conserve power until data is transmitted from said access points to one or more of the tags, whereupon the tags awaken again to receive data and transmit an acknowledgement to said access point when data is received.

7. The network of claim 1, wherein said controller updates electronic tags and the point of sale terminal simultaneously.

8. The network of claim 1, wherein said merchandise comprises a variety items manufactured by a variety of companies, whereby registration of the electronic tags with the access points maintains store location awareness of the merchandise.

9. The network of claim 1, wherein communication between said access points and said tags maintains a communication structure to minimize power drain on batteries of the electronic tags, whereby each of said electronic tags reads only messages that are identified by its address.

10. A method of messaging in a network to conserve power, comprising:
a) awakening by an electronic tag to receive a message beacon from an access point;
b) going back to sleep if address of the message beacon is not that of the electronic tag;
c) going back to sleep if address of the message beacon is that of the electronic tag to wait for data transmission; and
d) conducting a data transaction with said access point during a communication data slot.

11. The method of claim 10, further comprising:
a) dividing said message beacon into a plurality of sub-beacons;
b) placing a portion of an address of said electronic tag into each of said plurality of sub-beacons;
c) receiving a first sub-beacon by said electronic tag;
d) ignoring said message beacon by said electronic tag if there is no match between the address and that of the electronic tag, whereby the electronic tag goes back to sleep and waits for a next beacon; and
e) processing data being transmitted if a last sub-beacon is a match, otherwise said electronic tag goes back to sleep and waits for the next beacon.

12. The method of claim 10, wherein the electronic tag is a wireless messaging device couple to a merchandise located in a store.

13. The method of claim 10, wherein said message beacon is a transmitted signal from the access access attempting to communicate data with the electronic tag that is conserving battery power.

14. The method of claim 10, said message beacon notifies the electronic tag of impending data to be sent by the access point.

15. The method of claim 10, wherein conducting a data transaction further comprises:
a) waiting for a data slot by the electronic tag while in sleep mode;
b) sending a data packet contained within said data slot from the access point to the electronic tag;
c) sending an acknowledgement (ACK) from the electronic tag to the access point when the data packet is received, whereupon the access point sends in response an end-of-message (EOM); and
d) resending the data packet two additional times until the access point receives the ACK from the electronic tag, whereupon the access device sends the EOM.

16. The method of claim 15, wherein said electronic tag receives the EOM from the access point completing the data transaction, otherwise the electronic tag listens for retransmission of the EOM from the access point, and if retransmission of the data packet is not detected, the EOM is assumed to be lost, otherwise if the retransmission is detected by the electronic tag, the ACK is assumed lost and the electronic tag retransmits the ACK.

17. A method for registering an electronic tag, comprising;
a) generating a page to a first reserved address and transmitting the page from an access point to an electronic tag previously commissioned;
b) selecting a sub-slot by said electronic tag and posting tag identification numbers;
c) detecting the posting by the electronic tag; and
d) registering the electronic tag with the access point if the posting by the electronic tag places a short identification number (SID) into a second reserve address, otherwise return to step a) and repeat the process.

18. The method of claim 17, wherein electronic tag identification numbers comprise:
a) a unit identification number (UID) created at a factory creating a product;
b) a global trade identification number (GTIN) to identify the product; and
c) a short identification number (SID) that is a valid product identification number within a store, which is used to speed up registering a tag with an access device within the store.

19. The method of claim 17, wherein commissioning a tag comprises the method of:
a) issuing a first reserved address page (RA3) from a access point designated as a commissioning access point CAP;
b) selecting a sub-slot in the RA3 page by the electronic tag being commissioned and transmitting a packet comprising a unit identification number (UID) of the electronic tag; and
c) generating a second reserved address page (RA4) by the CAP and transmitted to the electronic tag, wherein the RA4 page comprises product identification numbers, therefore, completing a commissioning of the electronic tag.

20. The method of claim 19, where electronic product identification numbers further comprise:
a) a unit identification number (UID) created at a factory creating a product;
b) a global trade identification number (GTIN) to identify the product; and
c) a short identification number (SID) that is a valid product identification number within a store, which is used to speed up registering a tag with an access device within the store.

21. A method of updating and electronic tag, comprising:
a) generating an update for an electronic tag by a controller in a store;
b) coupling said update to all access points within the store;
c) determining a global trade identification number (GTIN) for the product being affected and ignoring the update by an access point not serving the product with the GTIN;
d) performing a paging operation to communicate the update to electronic tags comprising the GTIN; and
e) responding with an acknowledgement (ACK) from the electronic tags upon completion of the update, whereas no response assumes the product coupled to the electronic tag has moved, is no longer in the communication vicinity of access point and is removed from a database of the access point.

22. The method of claim 21, wherein said access point is a device that communicates with electronic tags coupled to merchandise within a store with wireless signals and is controlled by a store controller, which is coupled to point of sale terminal to provide up to date price and merchandise data.

23. The method of claim 22, wherein said access points are distributed in a store on walls and ceilings to provide communication to all merchandise coupled to electronic tags.

24. The method of claim 23, wherein said electronic tags are attached to merchandise or to shelving and other structures displaying the merchandise.

25. The method of claim 21, wherein said moved electronic tag will need to re-register with the access point in the communication vicinity of a new location of said electronic tag.

26. A method of replacing a failed access point, comprising:
a) replacing a failed access point with a new access point;
b) forming a group store identification (SID) for affected electronic tags associated with the failed access point;
c) transmitting the group SID to the electronic tags;
d) comparing most significant bits of the group SID by each of the affected electronic tags to the SID contained within each electronic tag;
e) responding by the electronic tags to the new access point with a unit identification number (UID and a global trade identification number (GTIN) for each electronic tag determining a match of the most significant of the group SID; and
f) creating a full SID by the new access point for each electronic tag responding to the group SID.

27. The method of claim 26, wherein said access point is a device that communicates with electronic tags coupled to merchandise within a store with wireless signals and is controlled by a store controller, which is coupled to point of sale terminal to provide up to date price and merchandise data.

28. The method of claim 27, wherein said access points are electronic devices that are distributed in a store on walls and ceilings to provide communication to all merchandise coupled to the electronic tags.

29. The method of claim 26, wherein said electronic tags are attached to merchandise or to shelving and other structures displaying the merchandise.

30. A system for electronic communication with merchandise on sale within a store, comprising:
a) a means for coupling an electronic identification device (tag) to merchandise on display within a store;
b) a means for distributing wireless communication devices (access points) throughout a store and coupled to a controller to communicate with a plurality of said electronic identification devices within said store;
c) a means for registering said tag to one of said access points;
d) a means for identifying a wireless message intended for said tag, whereby said tag is in low power state when not communicating with said access point; and
e) a means for updating price and merchandise parameters using wireless signaling between said access point and said tag.

31. The system of claim 30, wherein said means of coupling the tag to merchandise entails attaching the tag directly to said merchandise or attaching said to a shelf or display containing the merchandise.

32. The system of claim 30, wherein said means for distributing access points throughout a store entails positioning said access points on wall and ceilings of the store is such a way as to be able to communicate all merchandise comprising said tag.

33. The system of claim 30, wherein said means for registering entails wireless communication between the access point and the tag.

34. The system of claim 30, wherein said means for identifying the wireless message intended for the tag entails listening for a signal beacon sent by said access with a address of said tag and remaining in low power state until a data beacon is sent containing data intended for said tag, wherein said tag powers up to receive said data and to acknowledge receipt of the data to the access point.

35. The system of claim 34, wherein said means for updating price and merchandise parameters is through receiving data by the tag from the access point and acknowledging the receipt of the data.
